(19) United States
(12) Patent Application Publication
(10) Pub. No.: US 2004/0132369 A1
(43) Pub. Date: Jul. 8, 2004

(54) Filament bundle reinforcement fabric

(76) Inventors: Andrew A. Head, Cincinnati, OH (US); Thomas C. Story, Lakeside Park, KY (US)

Correspondence Address: DARBY & DARBY P.C., P. O. BOX 5257, NEW YORK, NY, 10150-5257, US

(21) Appl. No.: 10/337,512

(22) Filed: Jan. 7, 2003

(51) Int. Cl. D04H 3/12; B32B 5/08

(52) U.S. Cl. 442/269; 428/114; 428/293.7; 428/295.7; 428/298.1; 442/366

(57) ABSTRACT

A filament bundle reinforcement fabric is produced in a tubular structure with a minimum optimized amount of adhesive which is consistently and uniformly applied at a pitch to the machine direction or to the direction of the filament bundles in their formed state.

### FIELD OF THE INVENTION

This invention relates to a filament bundle reinforcement fabric used for liquid molding processes and, more particularly, to such a fabric including an optimized amount of adhesive applied to the filament bundle reinforcement fabric at a pitch to the machine direction (or parallel to the longitudinal axis of the machine mandrel) in order to bind the filament bundles in their formed state.

### BACKGROUND OF THE INVENTION

Preforms for liquid molding processes (LMP) are typically composed of layers of oriented filament bundles which are assembled and shaped prior to insertion into a mold. One type of filament bundle fabric is a flat sheet composed of dry filament bundles. This type of fabric can be produced as a tubular structure which is then slit either by machine or hand to create a flat sheet or produced in sheet form. However, it is difficult to orient the filament bundles in a predetermined orientation without weaving them and with the minimum amount of material holding them together. It is also difficult to place the filament bundles in a preform because of the tendency of the bundles to separate. Even if one were to successfully place a layer of dry unidirectional filament bundles in the preform, it is likely that during the molding process, the filament bundles will separate and shift, thus reducing part strength (i.e., the strength across a certain amount of fabric), and making it difficult to maintain part to part consistency.

One approach for production of the filament bundle fabric with adhesive in sheet form is to apply the adhesive to the sheet fabric by generally dripping the adhesive on the flat fabric, for example, in the shape of a sine wave or parallel lines. However, this approach limits the control over the amount and placement of the adhesive so that the sheet fabric has the following disadvantages: stiffness, crimping and a lack of symmetry in the application of the adhesive which reduces the symmetry and uniformity of the resulting fabric. Application of adhesive to the fabric introduces an impurity into the overall fabric matrix. If the amount and placement of the adhesive is not adequately controlled, then the impurity is inconsistent so that it imparts unpredictable properties from part-to-part of the fabric. Then, where the fabric is divided into sections and aligned for use in a liquid molding process, the different sections cannot be bonded together predictably. each of the sections does not have predictable properties

It would be desirable to provide a filament bundles reinforcement fabric with a minimum optimized amount of adhesive which is consistently and uniformly applied at a pitch to the machine direction of a the fabric produced in a tubular structure.

### SUMMARY OF THE EMBODIMENTS OF THE INVENTION

In one embodiment of the present invention, a filament bundle reinforcement fabric is produced in a tubular structure with a minimum optimized amount of adhesive which is consistently and uniformly applied at a pitch to the machine direction or to the direction of the filament bundles in their formed state.

### BRIEF DESCRIPTION OF THE DRAWINGS

FIG. 1 is a side view showing a machine for producing a filament bundle reinforcement fabric according to an embodiment of the present invention;

FIG. 2 is a perspective view of the yarn creel and guide units, respectively, according to the FIG. 1 embodiment of the present invention;

FIG. 3 is a perspective view of the yarn guide unit according to the FIG. 1 embodiment of the present invention;

FIG. 4a is a view taken along lines 4a-4a of FIG. 3 showing additional details of the yarn guide unit according to the FIG. 1 embodiment of the present invention;

FIG. 4b is a view taken along line 4b-4b of FIG. 4a showing the elevation of a yarn guide plate, according to the FIG. 1 embodiment of the present invention;

FIG. 5a is a top view of the wrapper unit according to the FIG. 1 embodiment of the present invention;

FIG. 5b is a perspective view of the wrapper unit along line 5b-5b shown in FIG. 5a according to the FIG. 1 embodiment of the present invention;

FIG. 5c is a side sectional view of the fabric including fabric and adhesive according to the FIG. 1 embodiment of the present invention;

FIG. 6 is a perspective view of fabric covering the mandrel, the end of the wrapper arm over which the adhesive travels and the adhesive, according to the FIG. 1 embodiment of the present invention;

FIG. 6a is a top view of the wrapper arm of FIG. 6 including the exit component and a portion of the wrapper arm, according to the FIG. 1 embodiment of the present invention;

FIG. 7 is a perspective view of fabric covering the mandrel, the end of the wrapper arm over which the adhesive travels, the adhesive and an alternative exit component, according to the FIG. 1 embodiment of the present invention;

FIG. 8 is a perspective view of a wrapper arm and accompanying structures for performing the third function of the wrapping unit, namely setting the adhesive into the fabric, according to the FIG. 1 embodiment of the present invention;

FIG. 9 is a perspective exploded view of a generic wrapper arm used to support any one of the three functions of the wrapper unit, according to the FIG. 1 embodiment of the present invention;

FIG. 10a is a perspective exploded view of wrapper arm used to support the first function of the mangler roller component, according to the FIG. 1 embodiment of the present invention;

FIG. 10b is a perspective exploded view of wrapper arm used to support the second function of wrapping the adhesive around fabric, according to the FIG. 1 embodiment of the present invention;

FIG. 10c is a perspective exploded view of wrapper arm used to support the third function of applying pressure and heat via the pressure roller, according to the FIG. 1 embodiment of the present invention;

FIG. 11a is a plan view of the wrapper unit with the wrapper arms positioned to accommodate a first diameter mandrel according to the FIG. 1 embodiment of the present invention;

FIG. 11b is a plan view of the wrapper unit with the wrapper arms positioned to accommodate a second diameter mandrel according to the FIG. 1 embodiment of the present invention; and

FIG. 12 is a plan view of the unidirectional non-woven fiber reinforcement produced by the process shown in FIGS. 1 to 11.

### DETAILED DESCRIPTION OF THE INVENTION

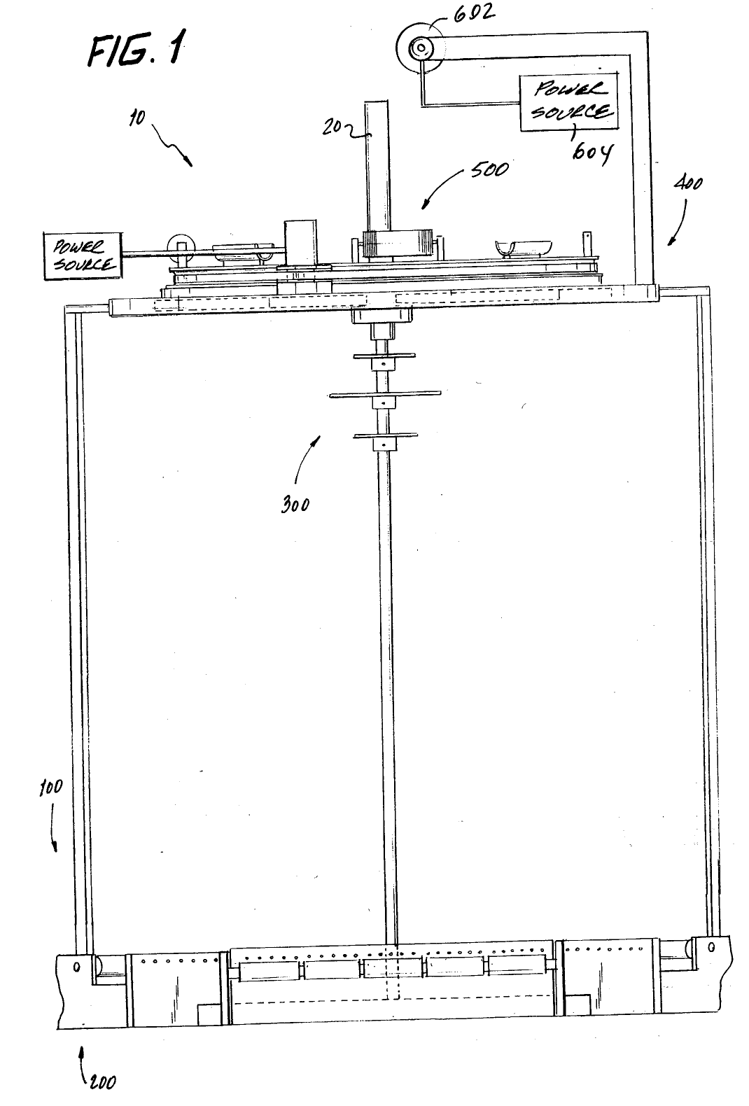

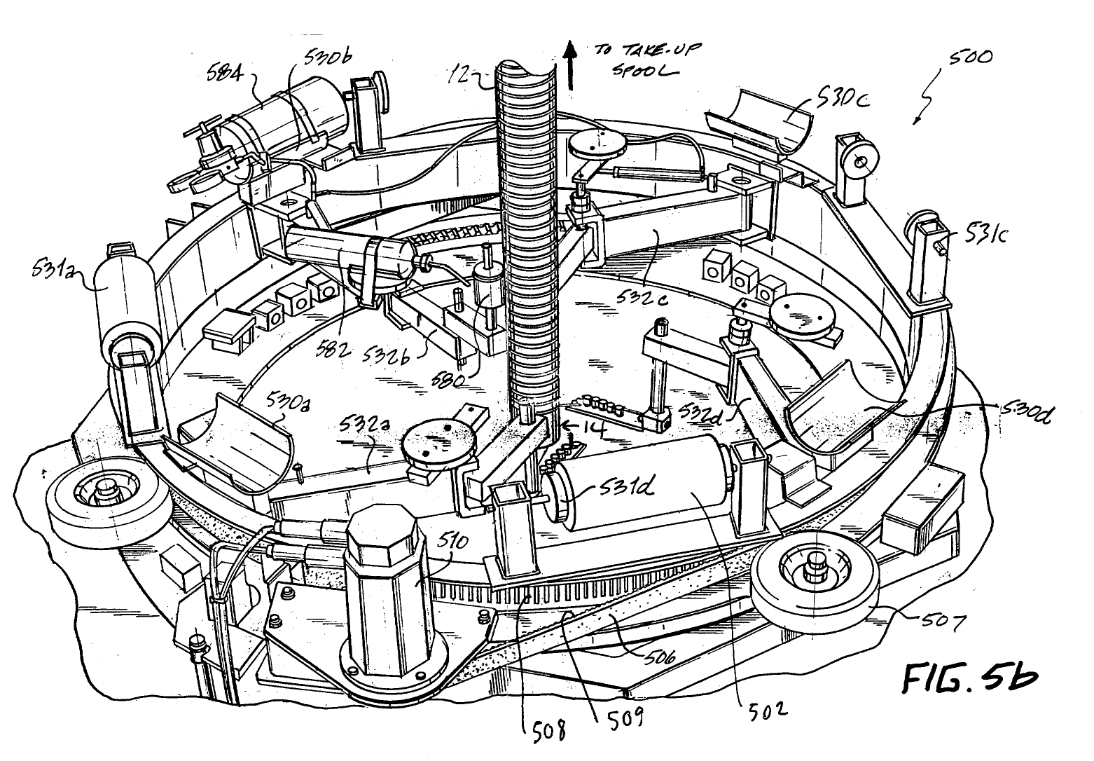

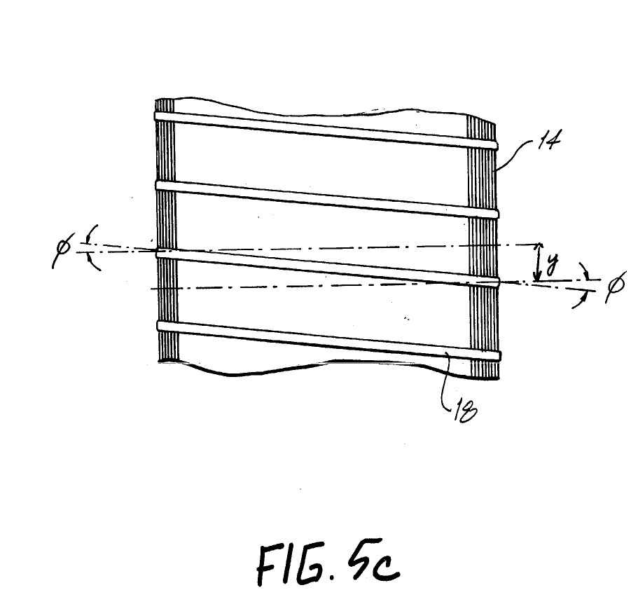

FIG. 1 is a side view showing a machine 10 for producing a filament bundle reinforcement fabric 12 (not shown; shown in FIG. 5b) according to an embodiment of the present invention. The machine 10 is stabilized by a stabilizing unit 100. The machine 10 includes a yarn creel unit 200, a yarn guide unit 300, a former ring unit 400 and a wrapper unit 500.

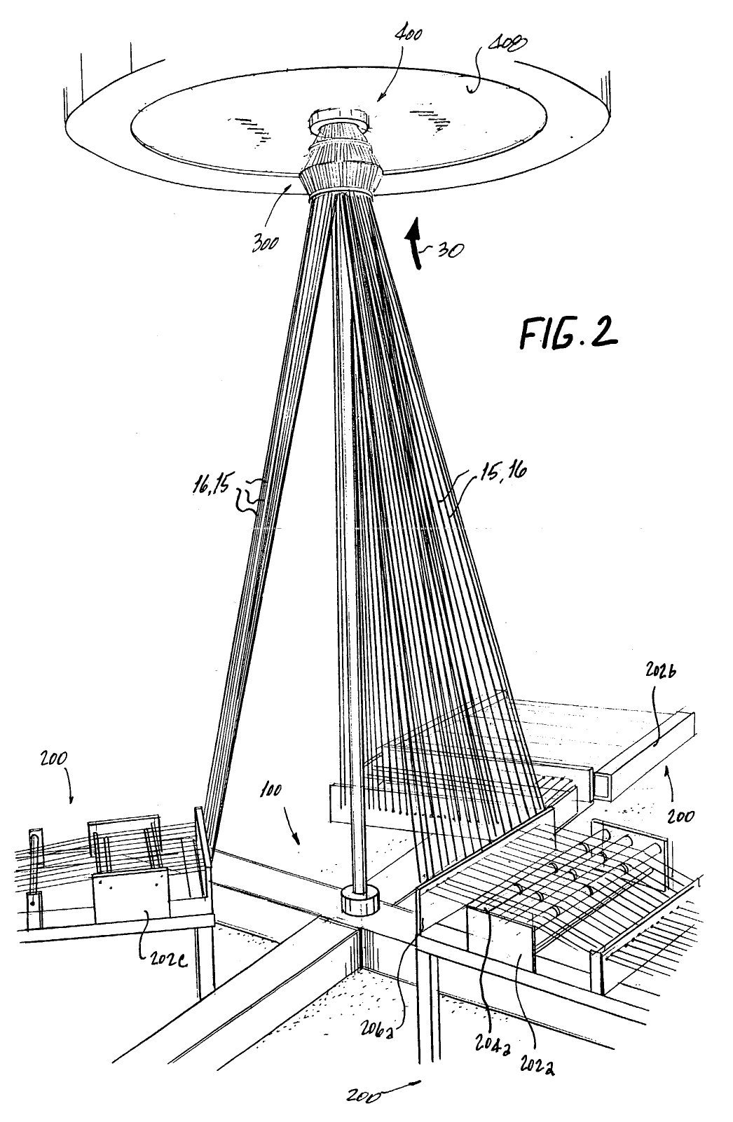

FIG. 2 is a perspective view of the yarn creel and guide units 200 and 300, respectively, according to the FIG. 1 embodiment of the present invention. Filament bundles 16 are formed into a plurality of tows 15 and fed from the yarn creel unit 200 through the yarn guide unit 300 and applied to a mandrel 20 (shown in FIG. 1) in the former ring unit 400. After the former ring unit 400, the tows 15 are processed by the wrapping unit 500 (shown in FIG. 1).

During passage through the creel unit 200, the filament bundles 16 in tows 15 are tensioned and spread out. The tows 15 move through the machine 10 in an upward direction, i.e., in the direction of arrow 30, based on an upward pulling force provided by a take-up servo capstan (not shown) or any other type of haul-off structure. A haul-off structure, including a take-up roller 602 and a power source for providing the pulling force 604 is shown in FIG. 1. Both a take-up servo capstan and other haul-off structures are known to one of ordinary skill in the art and therefore will not be further described herein. The tows 15 are applied to the mandrel 20 based on movement through the guide unit 300 during which the filament bundles 16 are further tensioned and spread out. The tows 15 then pass through the former ring unit 400 during which the filament bundles 16 of tows 15 are forced against the mandrel 20.

FIG. 2 also shows three creel units 202a,b, c. Yarn creel 202a includes a plurality of yarn packages 204a. Each yarn package 204a includes a plurality of spools of source filament bundles 16 in tows 15. Each yarn creel 202a also includes a guide plate 206a which assists in spreading out and tensioning the tows 15 delivered to the guide unit 300. The design, manufacture and use of creels 202 is well known to one of ordinary skill in the art. For example, Cyber Mill Toyota (Aichi, Japan) produces and is a commercial source for the following creels: Filamaster Creel, Conventional Yarn Creel, Trolley Fiber Creel and Swivel Yarn Creel, etc. Also, Izumi International (Greenville, S.C.) is a commercial source for a creel with model name Prepreg BFW Creel, as well as other creels. As a result, creel units will not be further described herein.

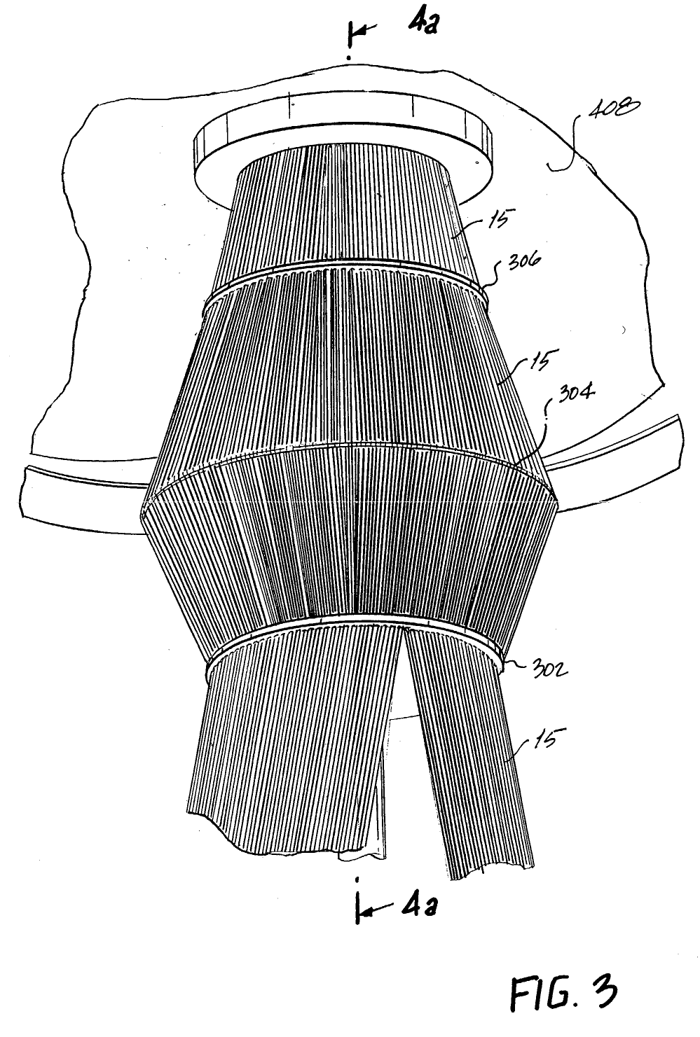

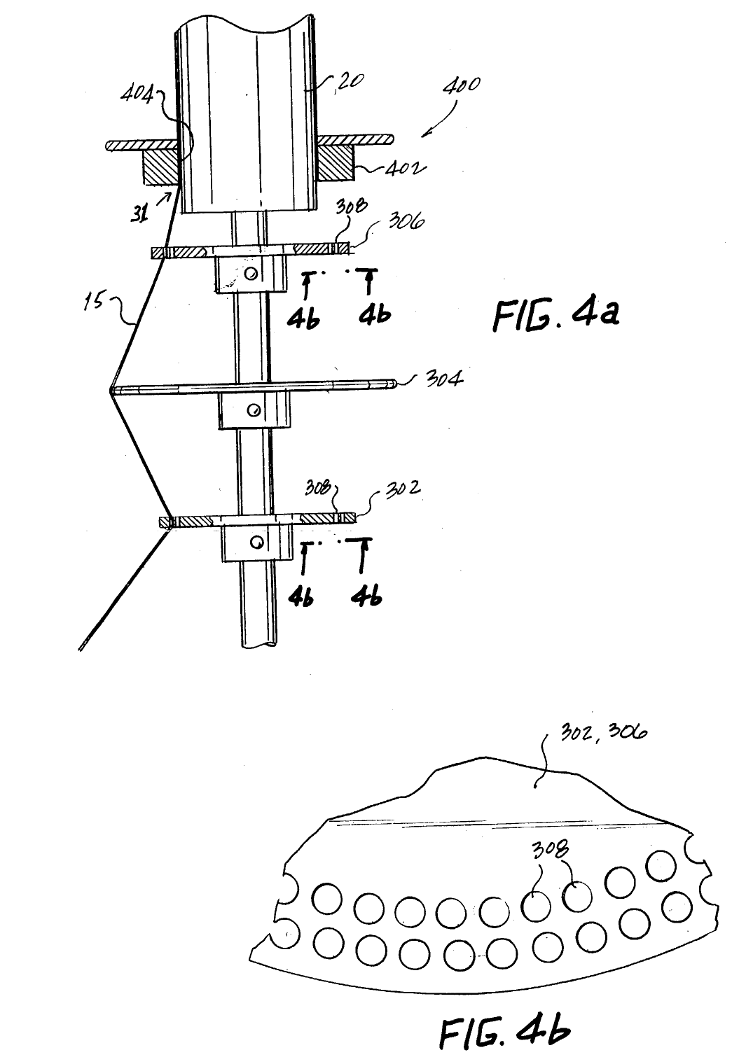

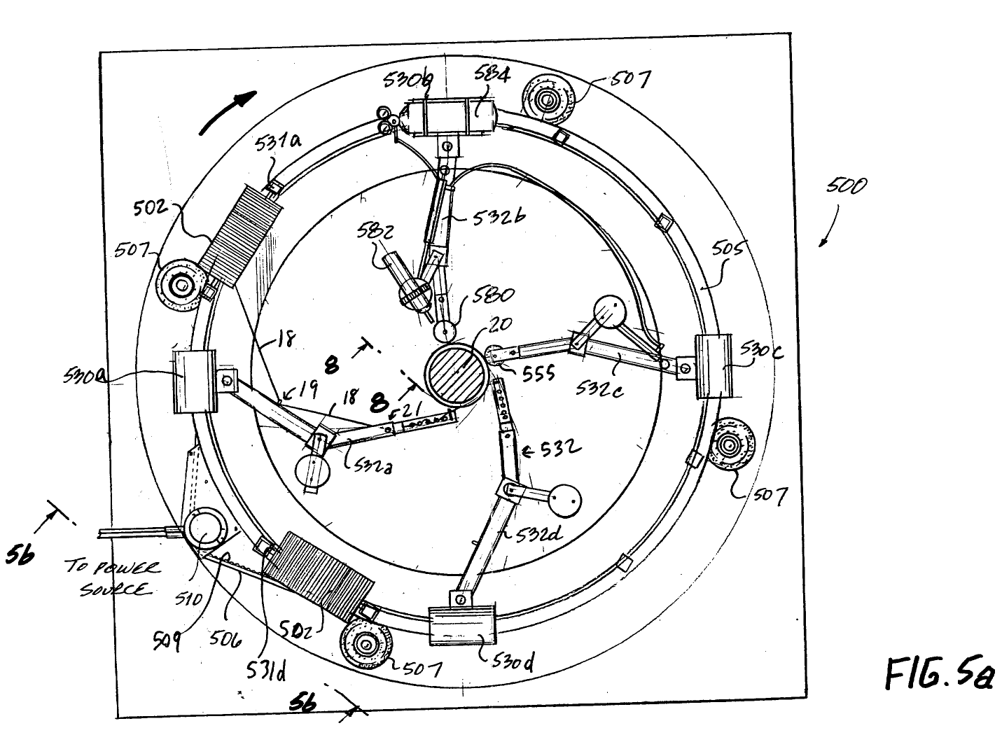

The filament bundles 16 formed into tows 15 are then pulled upward in the direction of arrow 30 toward the guide unit 300 (described in more detail in the text accompanying FIG. 3). At the exit point of the guide unit 300 is the former ring unit 400. The former ring unit 400 supports the introduction of the mandrel 20 (shown in FIG. 4a) and application of the tows 15 to the mandrel 20 at point 31 (shown in FIG. 4a).

FIG. 3 is a perspective view of the yarn guide unit 300 according to the FIG. 1 embodiment of the present invention. FIG. 4a is a view taken along lines 4a-4a of FIG. 3 showing additional details of the yarn guide unit 300. The yarn guide unit 300 includes a lower yarn guide plate 302, a middle yarn tensioning and spreading plate 304 and an upper yarn guide plate 306. Each tow 15 is guided and pulled through the identical lower and upper plates 302 and 306, respectively. In addition, the tensioning and spreading plate 304 is positioned in between the lower and upper plates 302 and 306, respectively, in order to apply tension and spread out the tows 15. The path of travel of tows 15 is as follows: first, through plate 302, than plate 304 followed by plate 306. Plate 302 is circular, made of steel and is about 5.5 inches in diameter. In alternative embodiments, the shape of the plate 302 can conform to any shape mandrel 20, e.g., a square, octagon, triangle etc.

FIG. 4b is a view taken along line 4b-4b of FIG. 4a showing the elevation of a yarn guide plate 302 or 306. Each of plate 302 and 306 contain holes 308 adjacent to the outer wall of the plates 302 and 306 and in the direction of travel of tows 15. The holes 308 are evenly spaced around the circumference of the plates 302 and 306 to ensure even yarn distribution. The diameter of the holes 308 are at least 1.5 times larger than the desired tow width of each tows 15 to prevent rounding over of the tows 15. Rounding over occurs when the edges of the tows 15 reside at points along the circumference of the holes 308 so that the edges naturally fold over the interior of the tows 15 when placed under tension rather than remaining on the edges of the tows 15. The size of the holds 308 also controls the aspect ratio of the tows 15. For example, plate 302 includes 192 holes around the circumference of a circle at a radial distance of 2.25 inches on plate 302. The holes 308 are 0.094 inches in diameter and the desired tow width of each tow 15 as an example is 0.0063 inches. In an alternative embodiment, smaller diameter holes can be used in order to increase the density of the tows 15 to produce a higher density fabric 12. Plate 306 is constructed in the same manner and serves the same function as plate 302. The tensioning and spreading plate 304 is positioned in between the upper and lower plates 302 and 306. The tows 15 track on the outside circumferential wall of plate 304. Plate 304 is 8 inches in diameter and is made of steel. It provides tension based on the serpentine path for the tows 15 that it creates between plates 302 and 306. Plate 304 also flattens the tows 15 based on the flat surface over which the tows 15 travels. The tensioning and spreading of tows 15 can be adjusted by moving the plates 302 and 306 relative to plate 304.

Referring further to FIG. 4a, the bottom of the mandrel 20 is located just below the former ring unit 400. Surrounding the mandrel 20 is a former plate 402 with an aperture 404 which conforms to the shape of the mandrel 20. and includes a diameter which is slightly larger than the diameter of the mandrel 20. The aperture 404 provides passage of the mandrel 20 through the former ring unit 400 and assists in applying the tows 15 to the mandrel 20. In this embodiment, aperture 404 is circular since the mandrel 20 is circular. However, in alternative embodiments, the aperture 404 can be any shape which conforms to the shape of the mandrel 20, e.g., square, triangle, elliptical, oval, amorphous, etc. The former plate 402 forces the tows 15 to form to the mandrel 20 based on the size of the gap between the inside wall of the former plate 402 and the mandrel 20, for example, a 1/32 inch gap. Surrounding the former plate 402 is a former ring support 408 (shown in FIG. 3). The former ring 408 includes an aperture which also surrounds the mandrel 20. The ring 408 can be removed and replaced with other size structures in order to accommodate different size or shape mandrels 20. As a result, the machine 10 can be reassembled to accommodate different size or shape mandrels 20 for various applications of fabric 12. The mandrel 20 in this embodiment is made of steel and is 3.82 inches in diameter.

FIG. 5a is a top view and FIG. 5b is a perspective view of the wrapper unit 500 along line 5b-5b shown in FIG. 5a according to the FIG. 1 embodiment of the present invention. The tows 15 move upward through former plate 402 for application against the mandrel 20. As applied to the mandrel 20, the filament bundles 16 of the tows 15 are aligned in their formed states to produce fabric 14 (shown in FIG. 5b) prior to the application of adhesive 18. The wrapping unit 500 (shown in FIGS. 5a and 5b) then applies adhesive 18 at a pitch to the longitudinal axis of the mandrel 20 (i.e., the machine direction) in order to bind the tows 15 into their formed state for the finished fabric 12. For example, the adhesive 18 can be wrapped at a range of pitch angles of 80.6 degrees (for 0.06 inch spacing between each wrap of adhesive 18) to 89.7 degrees (for 2.0 inch spacing between each wrap of adhesive 18). The pitch can also be any angle less than 89.7 degrees or, in an alternative embodiment, any angle less than 89.9 degrees. The pitch angle represents the acute angle from the machine direction of longitudinal axis of the mandrel (which is a zero degrees). In one embodiment, the machine direction can be aligned with the filament bundles 16, particularly where the filament bundles 16 are unidirectional fibers. The wrapping function is based on movement of the tows 15 through the unit 500 in combination with rotation of the unit 500 around the mandrel 20. The adhesive 18 is applied to the filament bundles 16 based on movement of adhesive 18 from an adhesive fiber package 502 through a wrapper arm 532 and finally for application to the mandrel 20. Downstream of the adhesive wrapping application, a heated pressure roller 580 is applied to the filament bundles 16 and the adhesive 18 to melt the adhesive 18 into the filament bundles 16 and to spread the filament bundles 16 in order to ensure full and even coverage of the finished fabric 12. Downstream of the wrapping unit 500, the fabric 12 can be further processed, including being slit along its longitudinal axis and laid flat for use as a non-tubular fabric (not shown). Such slitting can occur with the use of a machine or by hand by an individual slitting the fabric 12 with a scissors to create a flat fabric 12.

More particularly, the wrapper arm unit 500 includes a rotating ring 505 and a servo motor 510 for controlling the rotation of the ring 505 and the pitch of adhesive 18 wrapping around fabric 14. The ring 505 further includes a plurality of wrapper arms 532. Each of the wrapper arms 532 can further associated with a wrapper cradle 530 and a wrapper creel unit 531 which support structures relevant to the functions of the wrapper unit 500. The ring 505 and its component parts, the wrapper cradles 530 and wrapper arms 532 are made of stainless steel or in alternative embodiments any material for producing fabric components, as are well known to one of ordinary skill in the art. The ring 505 can be 50 inches in diameter.

Three functions are performed by the wrapper unit 500: first, mangling the filament bundles 16 of fabric 14 against the mandrel 20; second, wrapping the adhesive 18 around the filament bundles 16 of fabric 14 covering mandrel 20; and, third, setting the adhesive 18 into the fabric 14. Each wrapper arm 532 has the capability of supporting any of the first, second or third functions. For the first function, a wrapper arm 532 supports a mangler roller 555 which contacts fabric 14 upon exiting the former ring unit 400. The mangler roller 555 serves to further flatten and spread the fabric 14 against the mandrel 20. It also functions to eliminate any gaps between the tows 15 and to optimize the density distribution of the filament bundles 16. For the second function of wrapping the adhesive 18, a package 502 of adhesive 18 is placed in a wrapper creel unit 531 associated with a wrapper arm 532. The package 502 provides adhesive 18 to the wrapper arms 532 which in turn provides a path of travel for the adhesive 18 to the mandrel 20. For the third function of setting the adhesive 18, a pressure roller 580 is attached to the end of the wrapper arm 532 so that it contacts the fabric 14. In addition, a propane tank 582 is attached to the wrapper arm for providing a heating element to the pressure roller 580. A nitrogen tank 584 is also placed in the wrapper cradle 530 in order to provide a pressure source to the pressure roller 580. The tanks 582 and 584 provide heat and pressure to the pressure roller 580 in order to melt the adhesive 18 into the filament bundles 16 of fabric 14 and evenly spread out the adhesive 18. The pressure roller 580 also functions to eliminate any gaps between the tows 15 and to optimize the density distribution of the filament bundles 16. In an alternative embodiment, the mandrel 20 itself can also be heated to provide a melting force on the fabric 14. In still further alternative embodiments, only the mandrel 20 can be heated or the mandrel 20 in combination with the pressure roller 580 can be heated.

As shown in top view in FIG. 5a and perspective view in FIG. 5b, the rotating ring 505 is attached to a belt 506 by means of a tooth gear relationship between the outside wall of the ring 505 and the inside of the belt 506. The teeth 508 on the outside wall of the ring 505 (shown in FIG. 5b) grip the teeth 509 on the inside of the belt 506. A plurality of rotating tires 507 (for example, four tires) are evenly spaced around the circumference of the ring 505 and contact the outside of the belt 506 in order to assist in moving the belt 506. The belt 506 is driven by the servo motor 510. The motor 510 powers the belt 506 to rotate the ring 505. The connection between the belt 506 and motor 510 is also a tooth gear structure (not shown). The components and operation of motor 510 to engage and drive belt 506 and to thereby rotate ring 505 are well known to one of ordinary skill in the art and therefore will not be further described herein.

In the embodiment of FIG. 5a, there are four wrapper arms 532a,b,c,d. Each of the wrapper arms 532a,b,c,d can be associated with a wrapper cradle 530a,b,c,d and a wrapper creel unit 531a,b,c,d, respectively. One or more wrapper arms 532a,b,c,d can be used to provide the first function of wrapping the adhesive 18. In the FIG. 5a embodiment, three of the four wrapper arms, namely 532a and 532d are used. The packages 502 of adhesive 18 are located in wrapper creel units 531a and 531d. The adhesive 18 is fed from the packages 502 to the wrapper arms 532a and 532d and travel through a path on the wrapper arms 532a and 532d to exit at the end of the arms which is adjacent to the fabric 14 over mandrel 20. The adhesive 18 is then applied to the fabric 14 over mandrel 20. The adhesive 18 is wrapped in a spiral fashion onto the fabric 14 over mandrel 20 based on the rotation of the ring 505 and the movement of the fabric 14 upwards over the mandrel 20 (i.e., the haul-off). The speed of movement of these two structures determines the wrap pitch of adhesive 18. In addition, the ratio of the wrap speed versus the haul-off speed can be maintained by electrical or mechanical means. More particularly, the wrapper speed can be driven by a typical A.C. motor. The haul-off speed can be controlled by a mechanical gear train, a speed regulated motor or by electrical gearing etc. With a mechanical gear train, the gears must be physically changed to adjust speed and, as a result, pitch. This is a closed loop system. With a speed regulated motor, the speed can be dialed as input in order to yield a desired pitch. This is an open loop system. With electronic gearing, closed loop control can be obtained by using a position transducer on the wrapper and a servo motor on the haul-off. This can ensure precise control of the pitch and allows for ease of changing the pitch. Further details about design and control of the haul-off speed as well as wrapper speed are well known to one of ordinary skill in the art so that it will not be further described herein.

The use of two wrapper arms 532a and 532d for the wrapping function increases the amount of adhesive 18 that can be applied for a given rotation speed of the ring 505 and speed of the take-up servo constant. In alternative embodiments, any number of wrapper arms 532 can be used for the wrapping function to increase the amount of adhesive 18 or to allow a given amount of adhesive 18 with a reduced speed of upward movement of the fabric 14 over mandrel 20. In addition, as in FIG. 5a, wrapper arms 532 can be provided which are not used in the manufacture of fabric 12; rather, they are available on the machine for use in different applications where more or less wrapper arms 532 are needed. In still further alternative embodiments, only one wrapper arm 532 can be used for the wrapping function.

The first function of the mangler 555 applying pressure to the fabric 14 is performed by wrapping arm 532c. The second function of applying the adhesive 18 is performed by wrapping arm 532d. The third function of setting the adhesive 18 into the filament bundles 16 of fabric 14 is provided by wrapper arm 532b. Only one wrapper arm 532 is used for a pressure roller 580. However, in alternative embodiments, multiple pressure rollers 580 can be used. The pressure roller 580 is supported by wrapper arm 532b and the propane tank 582 is located on the wrapper arm 532b. The nitrogen tank 584 is located in the wrapper cradle 530b associated with the wrapper arm 532b. The heated pressure roller 580 is pressed up against fabric 14 based on operation of the nitrogen tank 584 so that it contacts the fabric 14 after application of the adhesive 18. The pressure roller 580 presses and melts the adhesive 18 into the filament bundles 16 of fabric 14. The pressure roller 580 rotates on its spindle and is further rotated by the rotational movement of the ring 505. Since heat and pressure are provided evenly around the surface area of the pressure roller 580, such properties are continuously transferred to the fabric 14. The pressure roller 580 can be heated to 350 degrees F. and can apply pressure within the range of 25 to 50 psi. These forces are sufficient to force adhesive 18 in molten form into the fabric 14.

The resulting fabric 12 includes the filament bundles 16 arranged in fabric 14 with adhesive 18 set into the fabric. Exemplary materials for the components of fabric 12 are as follows: the filament bundles 16 can be 12 k carbon fiber such as fiberglass, ceramic fibers, aramide fibers, or any of the range of glass fibers, basalt fibers etc. The filament bundles 16 can be any type of fiber with a length to diameter aspect ratio to make is sufficiently cord like, for example, an aspect ratio of 1000 to 1. An example of filament bundles 16 are unidirectional fibers or fibers aligned in the machine direction.

Generally, adhesive 18 is a bicomponent yarn or any combination of yarns where one yarn, an adhesive, has a low melting point compared to another yarn, a reinforcement yarn, which has a high melting point. In this way, when heated, the adhesive component melts and delivers adhesive to attach the reinforcement yarn to the fabric 14. For example, the reinforcment component of the bicomponent adhesive can be polyester. The adhesive component can be polyamide. The adhesive component acts as a bonding agent and the reinforcement component also provides support to the adhesive component so it does not break in the wrapping process. Other adhesives 18 involve any combination of a lower melting point component with a higher melting point component, such as where the lower melting point component is dipped, coated or extruded over the higher melting point component or the two components are braided, twisted, wound, spun or one component is placed as a jacket over the other. In further alternative embodiments, any means for combining the two components can be used to produce adhesive 18. Table 1 as follows presents several examples of adhesives 18: they are manufactured by Engineered Yarns (Fall River, Mass.) and include Reinforced Polyamide Adhesives with an example having a style number HM-3192, Reinforced Polyester Adhesives with an example having a style number HM-3181 and Reinforced EVA Adhesives with an example having a style number HM-3141. Further information about these adhesives is provided in Table 1 below.

TABLE 1
Examples of Adhesives 18 (Manufactured by Engineering Yarns, Fall River, MA)

| Style | FY-4044 | X-4170 | HM-3141 | HM-3192 | HM-3181 |
|---|---|---|---|---|---|
| Reinforcement | Polyester & | Polyester & | Nylon | Nylon | Aramid |
| | polymide | polymide | | | |
| Diameter (inches) | 0.015 | 0.011 | 0.007 | 0.009 | flat |
| Denier | 370 | 262 | 70 | 200 | 1500 |
| Yield (yds./lb.) | 12,042 | 17,858 | 17,220 | 7,780 | 2,160 |
| Melting Range | lower | lower | | | |
| | component: | component: | | | |
| | 105-120° C. | 105-120° C. | | | |
| | higher | higher | | | |
| | component: | component: | | | |
| | about 550° F. | about 550° F. | | | |

After application of adhesive 18 to fabric 14, pressure and heat are applied by the pressure roller 580 and propane tank 582 to force the lower melting temperature component to melt. An example of a diameter for adhesive 18 prior to application to the fabric 14 is, for example, 0.007 inches. In one embodiment with a particular adhesive 18, the diameter of the adhesive 18 remains generally the same prior to application to the tows 15 and after application to the tows 15 as well as being treated with pressure and heat from the pressure roller 550 and propane tank 552. This is because the lower melting temperature component of the adhesive 18 melts and flows when flattened by the heat and pressure. As a result, the adhesive 18 in flattened form generally has the same width as the diameter of the adhesive 18 before application in a generally rounded form. In another embodiment, where a different adhesive 18 is used, the diameter of the adhesive 18 prior to application to the fabric 14 can be 15 mm. However, after application to the fabric 14 and pressure and heat, the width of the adhesive 18 as melted into the fabric 14 is 20 mm, so that the adhesive 18 does spread based on the particular adhesive chosen, variations of the wrapping tension, pressure and heat from components 580 and 582, respectively.

FIG. 5c is a side sectional view of the fabric 12 including fabric 14 and adhesive 18. The purpose of this figure is to illustrate the pitch and specifications of the fabric 12 which are used to calculate it. The pitch angle is shown as Ø and y is the spacing of an adhesive 18 wrap during one revolution of the ring 505. The following mathematical relationship therefore applies:

Tangent Ø=2πr/x,

where Ø is the pitch or the acute angle measured from the machine direction or the longitudinal axis of the mandrel 20 which is 0 degrees;

r is the radius of mandrel 20; and,

x=(y) (the number of wrapping yarns), where y=yarn spacing; or,

x=the haul-off speed/the rotational speed of ring 505.

This calculation enables one to determine the pitch for given specifications of the machine and process. For example, where the speed of rotation of ring 505 is 20 revolutions/minute, the speed of upward movement of fabric 14 or the haul-off speed is 20 inches/minute, there are two wrapper arms applying adhesive at 20 revolutions per minute (based on movement of the ring 505) and the height of one wrap for one revolution is 1 inch per revolution, then the pitch of each of the wraps of adhesive 18 is 88.8 degrees. As another example, the speed of rotation of ring 505 is 30 revolutions/minute, the haul-off speed is 7.5 inches/minute with one wrapping arm and 0.25 inch spacing between wraps of adhesive 18, mandrel circumference of 1 foot, and the pitch of the adhesive is 88.8 degrees. For another example, where the speed of rotation of ring 505 is 30 revolutions/minute, the haul-off speed is 15 inches/minute, there are two wrapping arms with 0.25 inch spacing between each wrap of adhesive 18 and the mandrel circumference is 1 foot, the pitch of the adhesive is 87.6 degrees.

Another approach to describing the fabric 12 is based on percentage weight of adhesive 18 relative to the overall yield of fabric 12. More particularly, after adhesive 18 is set into the fabric 14 to create fabric 12, the adhesive 18 can be defined as having a particular percentage weight of the resulting fabric 14. For example, for adhesive 18 placed at 0.06 inch spacing, the percentage weight is 5.4%; for adhesive 18 placed at 2.0 inch spacing, the percentage weight is 0.18%; and, for adhesive 18 placed at 0.5 inch spacing, the percentage weight is 0.7%. The percentage weight can be calculated by an actual measurement of the respective parts of the fabric 12 separated after finishing. In the alternative, the percentage weight can be determined based on a calculation of the amount of adhesive 18 versus filament bundles in a given area. The following mathematical equation can be used:

$$Adhesive percentage yield = \frac{amount of adhesive ( sine ( pitch ) )}{\begin{matrix}amount of adhesive + \\ filament bundle fabric yield for the size of the fabric\end{matrix}}$$

where the amount of the adhesive=the size of the fabric/yarn spacing; and,

the filament bundle fabric yield for the size of the fabric is provided by the manufacturer (for example, for Engineered Yarns, HM-3192, the yield is 7,780 in yards per pound, see Table 1). An example of the application of this equation is as follows: the size of the fabric 12 used to determine the adhesive 18 percentage yield is one square foot with 0.25 inch spacing of adhesive 18 and a pitch of 88.8 degrees. The amount of adhesive 18 is the size of the fabric, 12 inches, divided by the yarn spacing, 0.25 inches, or 48. Each wrap is slightly less than 12 inches in length due to the placement of the adhesive 18 on a pitch. Due to the pitch, the amount of adhesive 18 can be calculated as 48 feet/sine (88.8 degrees) or 48/0.99978 or 48. The percentage weight of adhesive 18 is therefore the yield 48 of the adhesive 18 relative to the total yield of 196+48 or 244 of fabric 12, or 48/244=0.19%. Other examples of percentage weight are as follows: 5.4% with 0.06 inch yarn spacing; 0.18% with 2.0 inch yarn spacing; and, 0.7% with 0.5 inch yarn spacing. An exemplary yarn spacing range is 0.06 inches to 2.0 inches.

The adhesive yarn spacing effects the stability of the fabric 12. More particularly, the smaller the adhesive yarn spacing, the more stable the fabric 12 will be. This becomes important is the application of fabric 12 requires that the fabric on the cut ends does not displace or separate. However, with greater stability, the percentage weight of adhesive 18 increases, which can be a detriment for applications where a low percentage weight is desired.

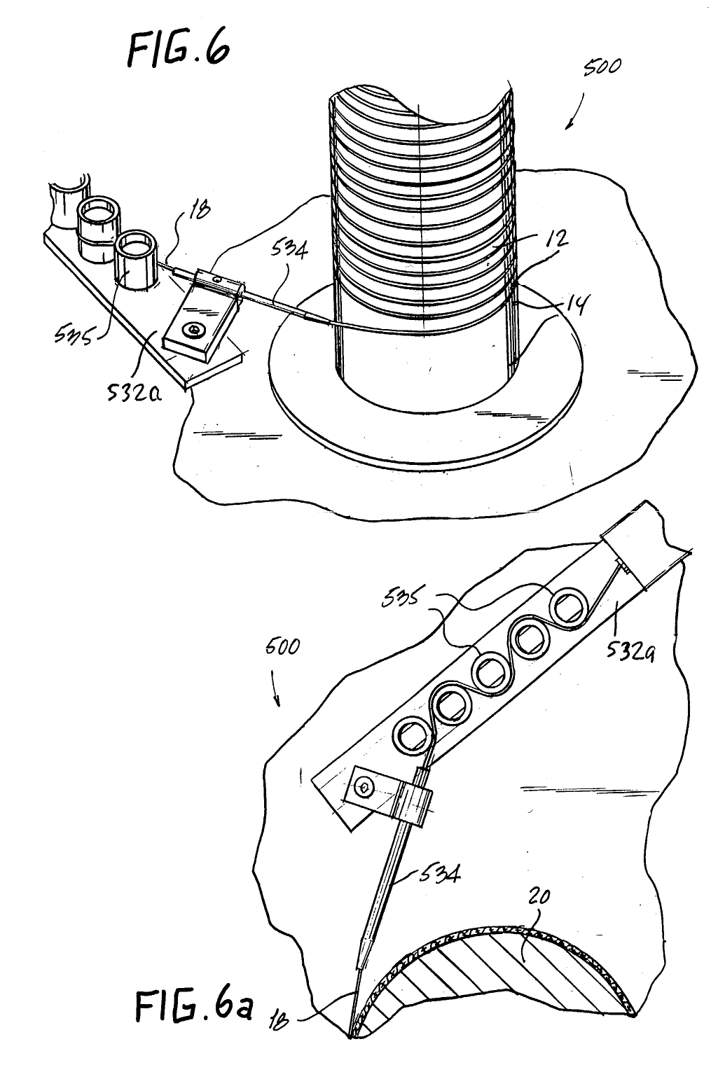

FIG. 6 is a perspective view of fabrics 14 and 12 covering mandrel 20, the end of the wrapper arm 532 over which the adhesive 18 travels and the adhesive 18. Fabric 14 includes tows 15 of filament bundles 16 prior to application of adhesive 18. Fabric 14 becomes fabric 12 upon application of adhesive 18. The wrapper arm 532 includes an exit component 534 for positioning and tensioning the adhesive 18 immediately before application to the fabric 14. The exit component 534 in the FIG. 6 embodiment is a tube through which the adhesive 18 is threaded. The exit component 534 tube is made of stainless steel and the eyelet aperture has a diameter of ⅛^{th} of an inch. Downstream of adhesive 18 application to the fabric 14, adhesive 18 travels from the wrapper creel unit 531a (shown in FIG. 5a) through point 19 and 21 on the wrapper arm 532a (shown in FIG. 5a) to the exit component 534. The adhesive 18 is then applied to the fabric 14 in a spiral fashion. In this embodiment, the distance along the longitudinal axis of the mandrel 20 in between two layers of the adhesive 18 is 0.25 inches. In alternative embodiments, such distances of between 0.060 and 2.0 inches are preferable in order to provide fabric stability. FIG. 6 also shows the fabric 14 with the adhesive 18 prior to the setting function of the pressure roller 580. This FIG. 6 does not show the mangler roller 555 on wrapper arm 532c or the corresponding function.

FIG. 6a is a top view of the wrapper arm 532a of FIG. 6 including the exit component 534 and a portion of the wrapper arm 532a. This FIG. 6a also shows a series of tension bars 535 through which the adhesive 18 travels on the wrapper arm 532a. Such tension bars 535 impart further tension to the adhesive 18 based on the serpentine path created for the adhesive 18.

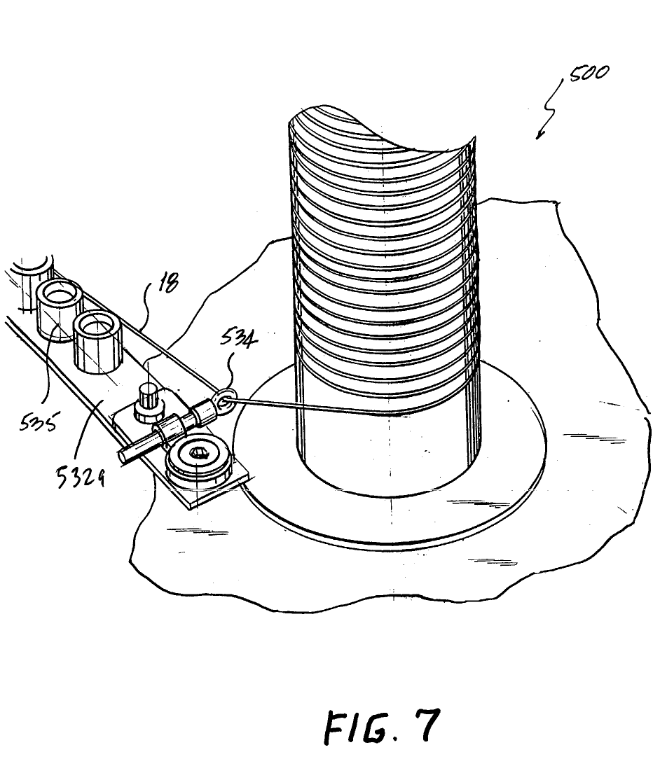

FIG. 7 is a perspective view of the fabric 14 covering mandrel 20, the end of the wrapper arm 532a over which the adhesive 18 travels and the adhesive 18. The wrapper arm 532a includes an exit component 534 for positioning and tensioning the adhesive 18 immediately before application to the fabric 14 covering mandrel 20. The exit component 534 in the FIG. 7 embodiment is an eyelet through which the adhesive 18 is threaded. The exit component 534 eyelet is made of stainless steel and it has an aperture with a diameter of ⅛^{th} inch.

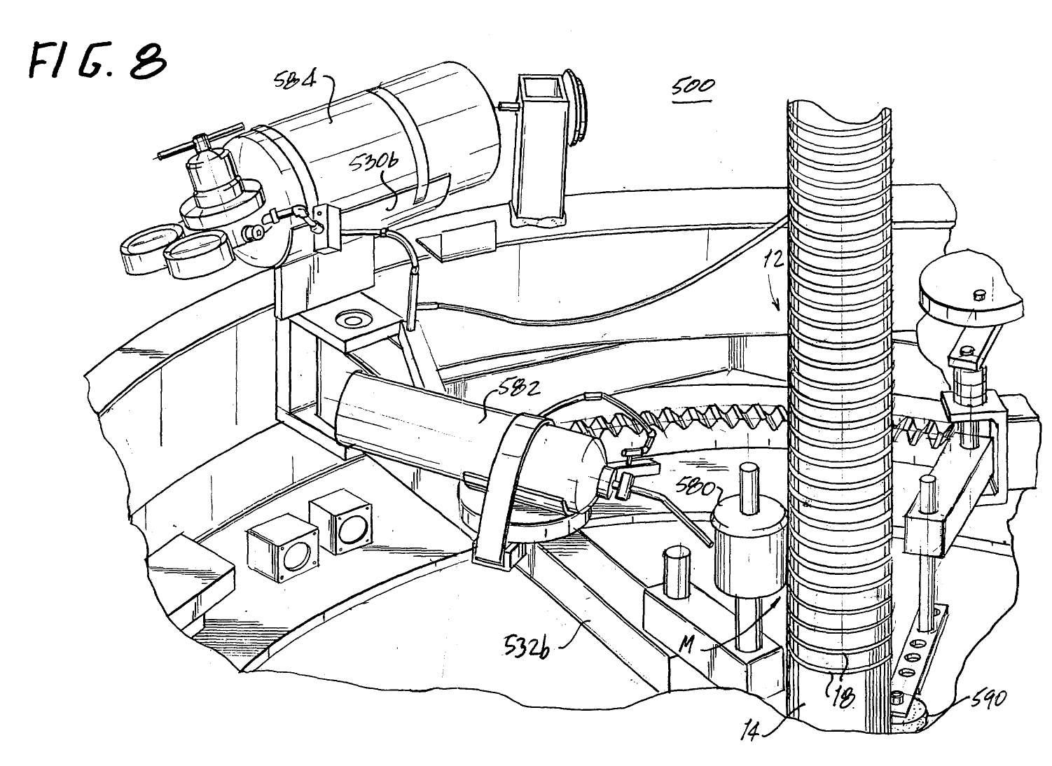

FIG. 8 is a perspective view of a wrapper arm 532b and accompanying structures for performing the third function of the wrapping unit 500, namely setting the adhesive 18 into the fabric 14 according to the FIG. 1 embodiment of the present invention. Wrapper arm 532b supports the pressure roller 580, propane tank 582 and nitrogen tank 584. The adhesive 18 is applied to the fabric 14 and is shown to have a smaller diameter as part of fabric 14 prior to application of pressure and heat by the pressure roller 50. Upon application of the pressure roller 580, as indicated by point M, the adhesive 18 is flattened and melted into fabric 14 to create fabric 12. The width of the adhesive 18 as measured on the surface of the fabric 12 increases in this embodiment. In another embodiment, depending on the particular adhesive 18 used, the diameter of the preapplied adhesive 18 can be the same as the width of the flattened applied adhesive 18.

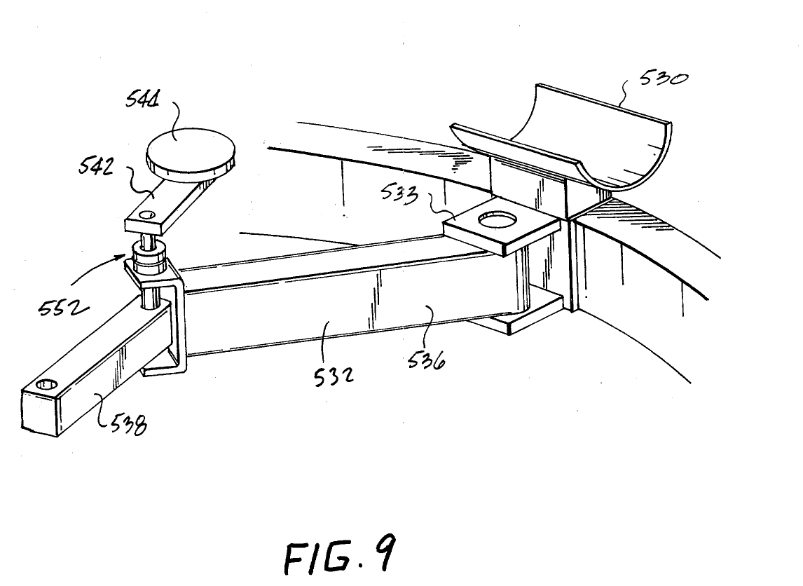

FIG. 9 is a perspective exploded view of a generic wrapper arm 532 used to support any one of the three functions of the wrapper unit 500. The wrapper arm 532 includes two support bars 536 and 538. Two swivel joints 533 and 552 enable the support arms to rotate in order to accommodate different diameters of mandrel 20. Attached above swivel joint 552 is a further support bar 542 connected to a counter weight 544. The counter weight functions to counter balance the centrifugal force created by rotation of ring 505. Exemplary lengths of each of arms 536 and 538 of wrapping arm 532 are 15 inches and 9 inches, respectively.

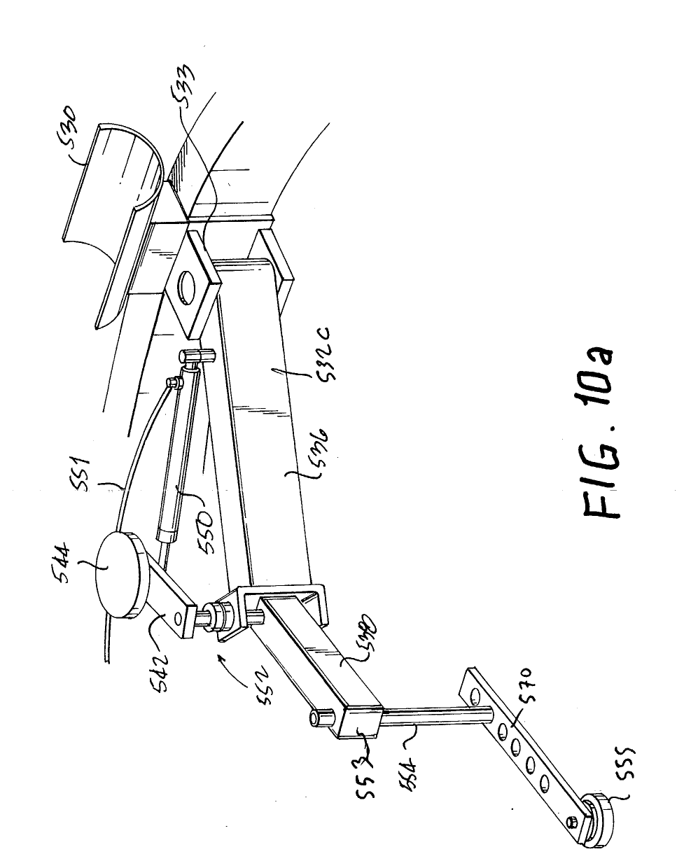

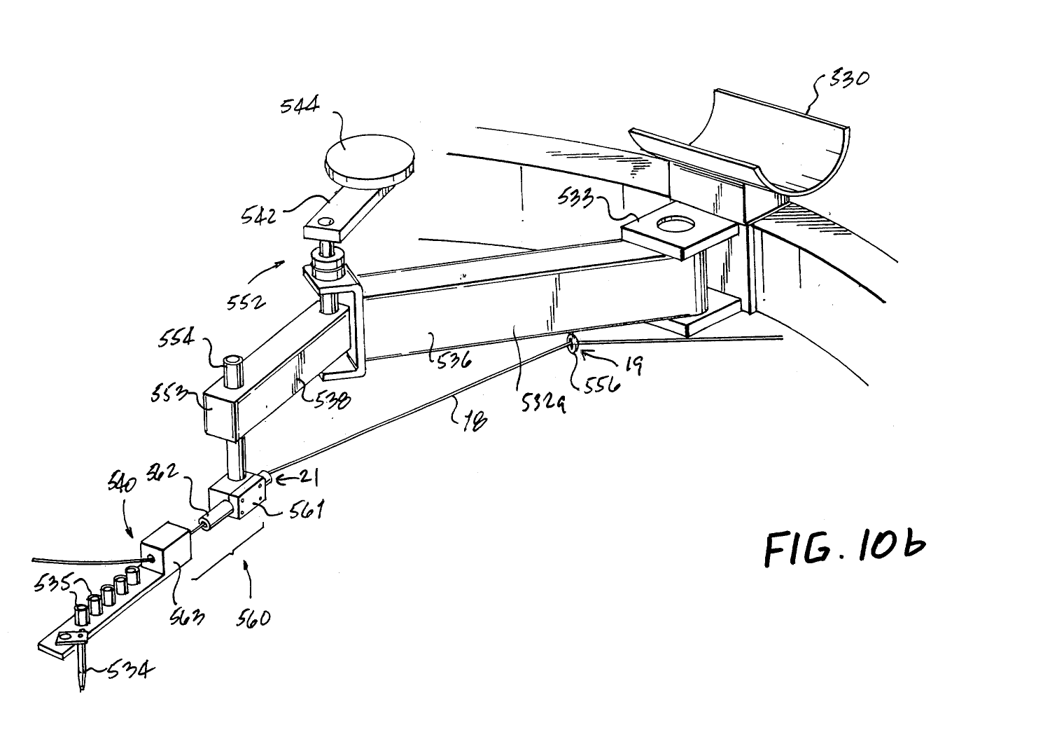

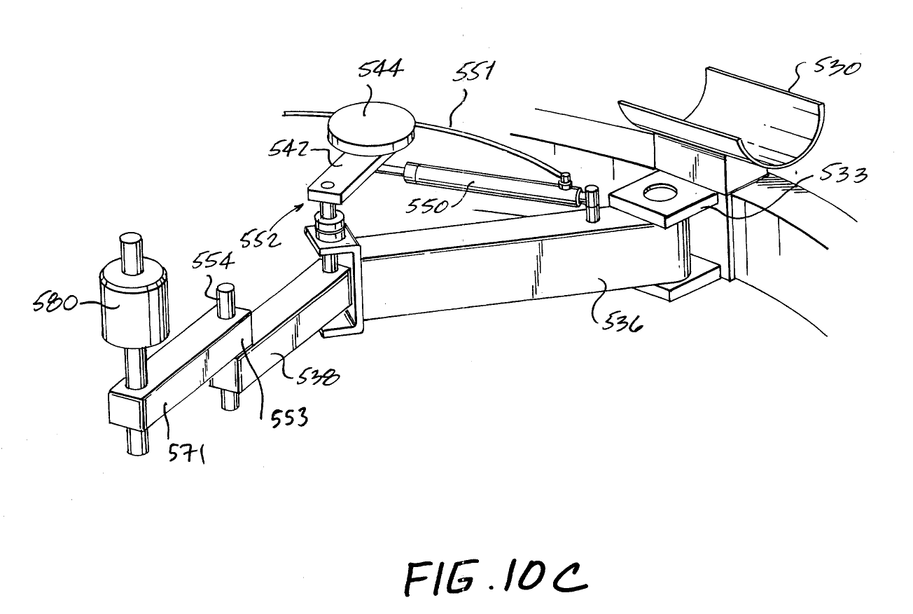

FIG. 10a is a perspective exploded view of wrapper arm 532c used to support the first function of the mangler roller 555 component, according to the FIG. 1 embodiment of the present invention. The mangler roller 555 can have the following specifications: a thickness of 0.5 inches thick, placement of 0.25 inches above the former ring unit 400 and a diameter of 1.5 inches and constructed of nylon. The following components are added to arm 532c in order to support the mangler roller 555 function: piston 550 is also be connected to support bar 536. The piston 550 functions to provide a pressing force to the fabric 14 on mandrel 20 based on a force provided by cylinder 551. An addition swivel joint 553 is provided to further enable the support arms to rotate in order to accommodate different diameters of mandrel 20. Swivel joint 553 is connected to a base 561 on which the mangler roller 555 is supported by an adjustable slide tube 554. The tube allows for adjustment of the vertical position of the base 570 to allow the mangler roller 555 to be applied at varying positions along mandrel 20.

FIG. 10b is a perspective exploded view of wrapper arm 532a used to support the second function of wrapping the adhesive 18 around fabric 14, according to the FIG. 1 embodiment of the present invention. FIG. 10b adds a number of components to the generic wrapping arm 532 of FIG. 9. One component is the support bar 540. This bar 540 includes the serpentine\tension bars 535, the exit component 534, and stabilization base 560. An exemplary length of the bar 540 is 9 inches. The stabilization base 560 includes a first block 561, a tube 562 and a second block 563 through which adhesive 18 travels for application to the fabric 14 on mandrel 20. An addition swivel joint 553 is provided to further enable the support arm 532a to rotate in order to accommodate different diameters of mandrel 20. Connecting swivel joint 553 to stabilization base 560 is an adjustable slide tube 554 for adjusting the vertical position of the support bar 540. This allows the adhesive 18 to be applied at varying positions along mandrel 20. Attached above swivel joint 552 is a further support bar 542 connected to a counter weight 544. The counter weight functions to counter balance the centrifugal force created by rotation of ring 505. The adhesive 18 travels from the package 502 through an eyelet 556 at point 19 on arm 532c to tube 562 on component 561 at point 21 and then, to the serpentine/tension bars 535 for a final exit through exit component 534.

FIG. 10c is a perspective exploded view of wrapper arm 532b used to support the third function of applying pressure and heat via the pressure roller 580. The components of arm 532b are the same as though for the generic arm 532 except for swivel joint 553 and tube 554 connecting to a base 571 which supports the pressure roller 580. The heat and pressure sources are not shown as they are well known to one of ordinary skill in the art.

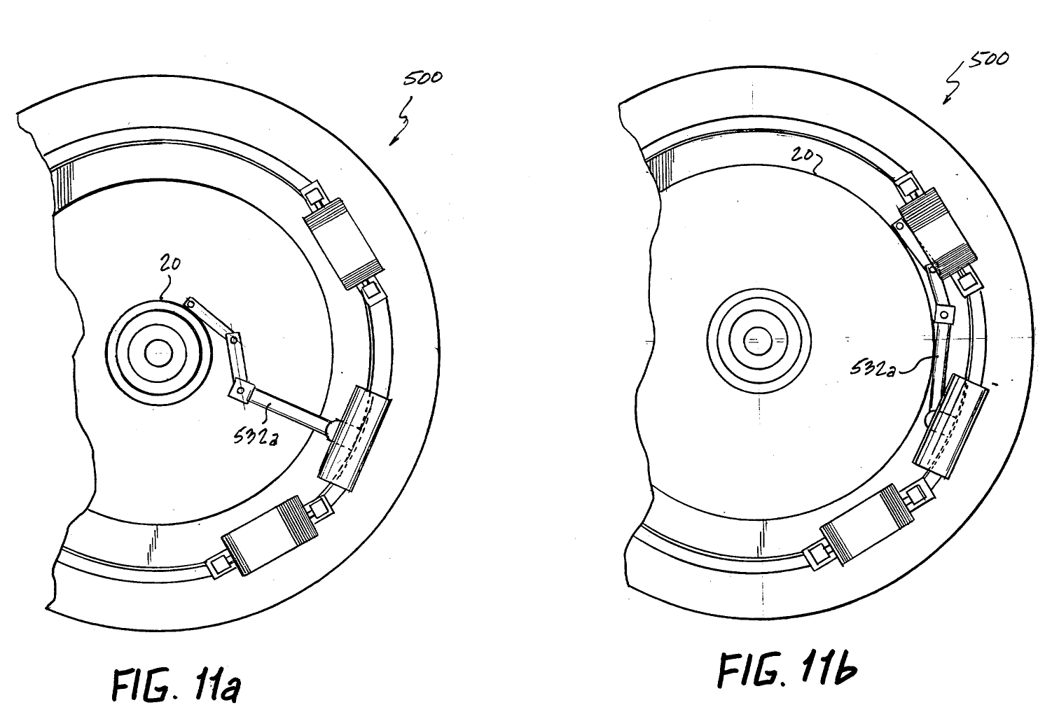

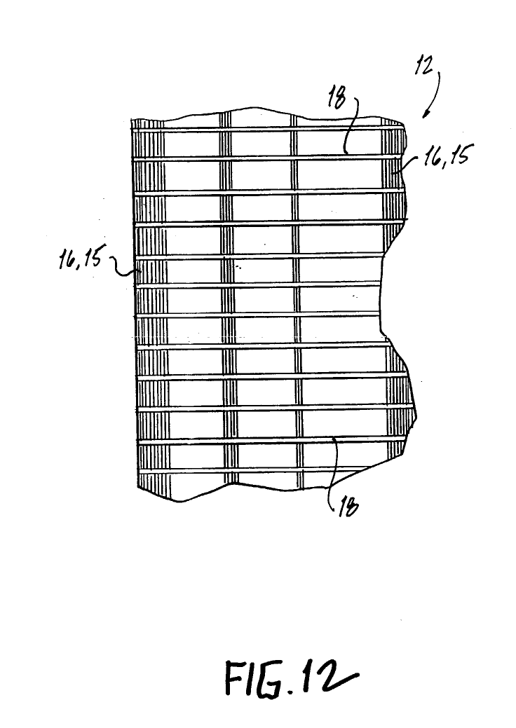

FIG. 11a is a plan view of the wrapper unit 500 with the wrapper arms 532 positioned to accommodate a first diameter mandrel 20 according to the FIG. 1 embodiment of the present invention. FIG. 11b is a plan view of the wrapper unit 500 with the wrapper arms 532 positioned to accommodate a second diameter mandrel 20 according to the FIG. 1 embodiment of the present invention. For example, the first diameter is 1.5 feet and the second diameter is 4 feet. The swivel joints 533, 553 and 554 of the wrapper arms 532 enable adjustability for wrapping the adhesive 18 about different diameters.

FIG. 12 is a plan view of the unidirectional non-woven fiber reinforcement 12 produced by the process shown in FIGS. 1 to 11. Shown are filament bundles 16 formed into tows 15 with adhesive 18 placed generally at a pitch to the machine direction. In addition, the fabric 12 can be slit and opened so that rather than a tubular product, the fabric 12 can be finished as a flat product. This can be readily accomplished by manually using a scissor or other cutting edge to cut along the longitudinal axis of fabric 12 and then opening the fabric 12 to form a sheet. In an alternative embodiment, the cut edge can be implemented on an angle to the machine angle so that, for example, where unidirectional fibers are used for the filament bundles 16 and the unidirectional fibers are oriented along the machine direction, the filament bundles 16 of the cut fabric 12 are not aligned along the longitudinal axis of the cut fabric 12. The angle of the filament bundles 16 in a flat fabric 12 can be varied depending on the application of fabric 12.

While the invention has been particularly shown and described with reference to multiple embodiments, it will be understood by those skilled in the art that various changes in form and details may be made therein without departing from the spirit and scope of the invention.

We claim:

1. A filament bundle reinforcement fabric, comprising:
a plurality of filament bundles formed into a plurality of tows, the tows being generally aligned parallel to each other; and,
an adhesive being at least partially melted into the tows and being positioned at a pitch to the direction of the tows, the percentage weight of the adhesive being one of 5.4% or less than 5.4% of the total weight of the filament bundles and the adhesive.

2. The filament bundle of claim 1 wherein the percentage weight of the adhesive is between 5.4% and 0.7%.

3. A filament bundle reinforcement fabric, comprising:
a plurality of filament bundles formed into a plurality of tows, the tows being generally aligned parallel to each other; and,
an adhesive being at least partially melted into the tows and being positioned at a pitch to the direction of the tows, the pitch being one of 89.7 degrees and less than 89.7 degrees.

4. The filament bundle of claim 3 wherein the pitch of the adhesive is between 89.7 degrees and 80.6 degrees.

5. A filament bundle reinforcement fabric, comprising:
a plurality of filament bundles formed into a plurality of tows, the tows being generally aligned parallel to each other; and,
an adhesive being at least partially melted into the tows, having an adhesive yarn spacing along the direction of the tows and being positioned at a pitch to the direction of the tows, the pitch being one of 89.7 degrees with an adhesive yarn spacing of 0.06 inches and less than 89.7 degrees with an adhesive yarn spacing of 0.06 inches.

6. The filament bundle of claim 5 wherein the pitch of the adhesive is between 89.7 degrees with an adhesive yarn spacing of 0.06 inches and 80.6 degrees with an adhesive yarn spacing of 2.0 inches.

7. A filament bundle reinforcement fabric, comprising:
a plurality of filament bundles formed into a plurality of tows, the tows being generally aligned parallel to each other; and,
an adhesive being at least partially melted into the tows, having an adhesive yarn spacing along the direction of the tows and being positioned at a pitch to the direction of the tows, the adhesive yarn spacing being one of 2.0 inches and less than 2.0 inches.

8. The filament bundle of claim 7 wherein the adhesive yarn spacing is between 2.0 inches and 0.06 inches.

9. A process for preparing a filament bundle reinforcement fabric, comprising:
a) providing a plurality of filament bundles formed into a plurality of tows;
b) applying the tows to a mandrel and pulling the tows along the mandrel, the mandrel having a longitudinal axis;
c) wrapping an adhesive around the tows on the mandrel at a pitch to the longitudinal axis of the mandrel while the tows are moving along the mandrel; and,
d) applying pressure and heat to the adhesive to set it into the tows on the mandrel.

10. The process of claim 9 wherein the percentage weight of the adhesive melted into the tows is between 5.4% and 0.7% of the total weight of the filament bundles and the adhesive.

11. The process of claim 9 further comprising cutting the combination of tows and the adhesive to create a flat fabric.

12. A process for preparing a filament bundle reinforcement fabric, comprising:
a) providing a plurality of filament bundles formed into a plurality of tows;
b) applying the tows to a mandrel and pulling the tows along the mandrel, the mandrel having a longitudinal axis;
c) wrapping an adhesive around the tows on the mandrel at a pitch to the longitudinal axis of the mandrel while the tows are moving along the mandrel; and,
d) applying pressure and heat to the adhesive to set it into the tows on the mandrel, the pitch being one of 89.7 degrees and less than 89.7 degrees.

13. The process of claim 12 wherein the pitch of the adhesive is between 89.7 degrees and 80.6 degrees.

14. The process of claim 12 further comprising cutting the combination of tows and the adhesive to create a flat fabric.
